(19) United States
(12) Patent Application Publication
(10) Pub. No.: US 2011/0142297 A1
(43) Pub. Date: Jun. 16, 2011

(54) Camera Angle Compensation in Iris Identification

(75) Inventors: Hsiang-Yi Yu, Chantilly, VA (US); Evan R Smith, Chantilly, VA (US)

(73) Assignee: Eye Controls, LLC, Chantilly, VA (US)

(21) Appl. No.: 12/639,995

(22) Filed: Dec. 16, 2009

(51) Int. Cl. G06K 9/32; G06T 7/00

(52) U.S. Cl. 382/117; 382/296

(57) ABSTRACT

An iris biometric image is analyzed to determine the apparent angle of the eye in the image, relative to an arbitrarily selected reference axis. The angle information is stored for use by the matching engine and/or the image data is modified to normalize the angle relative to the reference axis. In this manner, rotationally normalized data may be stored to facilitate future comparisons, and images obtained in real time may be used for iris identification in a matching engine that automatically compensates for angular variation.

### FIELD OF THE INVENTION

The present invention is directed generally to the field of capturing and processing images for biometric iris identification.

### BACKGROUND

Iris identification is recognized as one of the most user-friendly and accurate biometric technologies. Iris identification uses digital cameras to capture an image of the iris. Commercially available cameras are designed either to capture a single eye image or to simultaneously capture images of both irises.

Iris identification is performed by matching pattern data extracted from a captured iris image to previously stored pattern data. Therefore, the angle of presentation of the iris in the image will affect the ability to match the image to a stored iris pattern. If the subject tilts his head or the eye is torsionally rotated within the subject's head while the image is being captured, or if a handheld camera is positioned at an angle relative to the person's head, the captured image will show the eye at an angle. Ideally, both the stored pattern data and the pattern data for comparison are derived from images where the eye is at the same angular position in the image. But in practice, even when every effort is made to carefully position the camera and avoid head tilt and eye rotation during iris imaging, some relative rotational angle will inherently exist between any two pattern data sets being compared. If not dealt with, this relative angle between the pattern data sets will result in failure to find a match, although the two sets of pattern data are from the same eye. This type of error is called a “false reject” and angular variations in imaging can potentially cause significant rates of false rejection.

In the prior art, multiple matching attempts with the pattern data sets at different relative angles are used to compensate for the existence of angular imaging variation and limit false rejects arising from eye angle. For example, the pioneering iris algorithm developed by Dr. John Daugman and disclosed in U.S. Pat. No. 5,291,560 encodes pattern data using polar coordinates, and then performs multiple comparisons by laterally scrolling the angularly encoded pattern data sets at several positions, both left and right. In effect, this method tries a series of different relative rotations of the two sets of pattern data to see if a match can be found within a defined range of rotation.

This approach has been empirically effective to correct for small angular variations. However, there are disadvantages to this approach. The limits of the angular compensation are established by the number of additional comparisons that are performed. Each of these extra comparisons takes time.

Commercial iris algorithms sometimes have a parameter that is set to establish how many additional comparisons are performed for each matching attempt. This parameter specifies the range of relative rotations in which matches will be found. For example, a matching engine might be set up to find matches within a range of plus or minus seven degrees of angle. If two sets of pattern data for the same iris are submitted to that matching engine, and their relative rotation is within the established range (for example less than seven degrees difference) a match will be found. If the head is tilted by (for example) ten degrees in one of the images under comparison, no match will be found even though the irises are the same, resulting in a false reject.

With this traditional approach, there is a well-understood tradeoff between the rate of false rejects due to image angle, and the time required to perform additional comparisons to prevent false rejects arising from angular variations. If a one-to-one match is being performed, to verify a previous tentative identification of the subject, the time issue is not significant. However, when performing a one-to-many search in a large database, the number of comparisons required is already very large, even before the addition of further comparisons for angular compensation. The time required for a search increases significantly as the range of angular compensation is increased. In a large database search, this additional computation time becomes a barrier to real time operations and objectionable to end users.

The inventors have identified another potential downside of this approach. The farther a set of pattern data is rotated from horizontal during the comparison process in an effort to avoid angular-based false rejects, the greater the likelihood that the set of pattern data will be erroneously matched against pattern data from other eyes at different angles. In the prior art method, most of the comparisons of different eyes at different angles are actually comparing pattern data that was captured at significant relative rotations. Comparing the pattern data from an eye imaged at an angle of +10 degrees from the horizontal to pattern data of an eye imaged at −10 degrees from the horizontal should never produce a valid match. Yet, with this method, a large number of irises may be compared in this manner and eventually a false acceptance may occur.

Thus, the inventors have determined that there is a need for improved methods of dealing with iris images where the eye is seen at an angle, i.e. rotated.

### SUMMARY OF THE INVENTION

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description.

In a first example embodiment, an iris image is analyzed to determine the apparent angle of the eye in the image, relative to an arbitrarily selected reference axis (for example, a horizontal line passing through the center of the pupil image). Then, the image and/or pattern data extracted from the image is digitally rotated to normalize the angle relative to the reference axis. In an enrollment mode, the resulting angularly normalized data can be stored to create an angularly normalized database to support future identification operations. In a recognition mode, the angularly normalized data can be compared to one or more stored iris patterns by a matching engine that provides only a limited range of angular compensation.

In another example embodiment, image or pattern data is analyzed to determine the apparent angle of the eye, and this information is used as an input to an iris matching engine to determine how the data should be rotated in a comparison operation.

In one method, the center of the eye in an image is first located, for example by using image analysis library routines provided with commercially available iris identification software for this purpose. A contrast stretch function, a smoothing or defocusing algorithm, an edge detection function, and thresholding are applied at least to the eye region. The result is an image that contains a generally elliptical shape. An ellipse-fitting algorithm is then applied to the image with (for example) the center of the ellipse set to the coordinates of the eye's center. An angle between the central longitudinal axis of the fitted ellipse and a selected reference axis is then determined and that information is either stored for future reference and/or used to normalize the angle of the image or stored pattern data extracted from the image.

In another method, the center of the eye is located and a region that is likely to encompassing the eyelids and corners of the eye is determined based on the eye center location. A smoothing function is applied, and a matrix that defines a corner pattern is convolved with pixel values of the iris image so that the resulting image pixel values have a maximum value at an eye corner. This process is repeated for both corners if they are present in the image. If not, one corner is identified and another point such as the center of the pupil is used. The angle between a line connecting the two eye corners (or other point as needed) and the selected reference axis is then determined and that information is stored for future reference and/or used to normalize the angle of the image or stored pattern data extracted from the image.

Additional features and advantages of the invention will be set forth in the description which follows, and in part will be apparent from the description, or may be learned by practice of the invention. The advantages of the invention will be realized and attained by the structure particularly pointed out in the written description and claims hereof as well as the appended drawings.

### BRIEF DESCRIPTION OF THE DRAWINGS

The accompanying drawings, which are incorporated herein and form a part of the specification, illustrate various exemplary embodiments of the present invention and, together with the description, further serve to explain various principles and to enable a person skilled in the pertinent art to make and use the invention.

FIG. 1 is a diagram of an iris image illustrating angular rotation;

FIG. 2 is a flow chart showing an exemplary embodiment of an iris identification process including eye rotation compensation;

FIG. 3 is a flow chart showing an embodiment of a process for determining eye angle in a digital image;

FIG. 4a is a digital iris identification image that has been processed by contrast stretching;

FIG. 4b shows the digital iris identification image of FIG. 4a with a smoothing algorithm applied;

FIG. 4c shows the digital iris identification image of FIG. 4b further processed using a Sobel edge detection algorithm;

FIG. 4d shows the image of FIG. 4c that has been further processed with a thresholding algorithm;

FIG. 4e shows the image of FIG. 4d with an ellipse fitted thereto;

FIG. 5 is a flow chart showing another embodiment of a process for determining eye angle in a digital image;

FIG. 6a shows the digital image of FIG. 1 reduced in size for faster processing in the method of FIG. 5;

FIG. 6b shows the digital image of FIG. 6a after further processing with a smoothing algorithm;

FIG. 6c shows the digital image of FIG. 6b after convolution with a right-corner detection matrix; and

FIG. 6d shows the image of FIG. 6c after thresholding to highlight the right corner of the eye.

### DETAILED DESCRIPTION OF THE PREFERRED EMBODIMENTS

The present invention will be described in terms of one or more examples, with reference to the accompanying drawings. In the drawings, some like reference numbers indicate identical or functionally similar elements. Additionally, the left-most digit(s) of most reference numbers may identify the drawing in which the reference numbers first appear.

The present invention will be explained in terms of exemplary embodiments. This specification discloses one or more embodiments that incorporate the features of this invention. The disclosure herein will provide examples of embodiments, including examples of data analysis from which those skilled in the art will appreciate various novel approaches and features developed by the inventors. These various novel approaches and features, as they may appear herein, may be used individually, or in combination with each other as desired.

In particular, the embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, persons skilled in the art may implement such feature, structure, or characteristic in connection with other embodiments whether or not explicitly described.

Embodiments of the invention may be implemented in hardware, firmware, software, or any combination thereof, or may be implemented without automated computing equipment. Embodiments of the invention may also be implemented as instructions stored on a machine-readable medium, which may be read and executed by one or more processors. A machine-readable medium may include any mechanism for storing or transmitting information in a form readable by a machine (e.g. a computing device). For example, a machine-readable medium may include read only memory (ROM); random access memory (RAM); hardware memory in handheld computers, PDAs, mobile telephones, and other portable devices; magnetic disk storage media; optical storage media; thumb drives and other flash memory devices; electrical, optical, acoustical, or other forms of propagated signals (e.g. carrier waves, infrared signals, digital signals, analog signals, etc.), and others. Further, firmware, software, routines, instructions, may be described herein as performing certain actions. However, it should be appreciated that such descriptions are merely for convenience and that such actions in fact result from computing devices, processors, controllers or other devices executing the firmware, software, routines, instructions, etc.

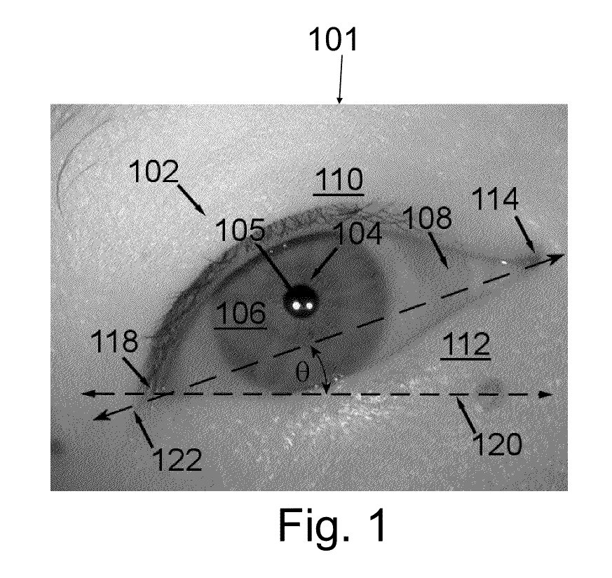

FIG. 1 illustrates an eye image 101 that is a digital picture of eye 102. Eye 102 comprises pupil 104 with center 105, iris 106, and schlera 108. The intersection of upper eyelid 110 and lower eyelid 112 defines an inner corner 114 (proximate to the tear duct) and an outer corner 118. A reference line 120 is arbitrarily selected. A single reference line may be selected or, since a goal of the reference line is to determine an angle between the reference line and the eye orientation, a reference orientation may be selected and any line parallel to that reference orientation may be used. In this example reference line 120 is shown as a line parallel to a central horizontal axis of image 101 and any such parallel line may be used as reference line 120 to produce the desired result. An ocular horizontal axis 122 passing through inner corner 114 and outer corner 118 is an approximation of a central horizontal axis of eye 102. Angle θ between reference line 120 and ocular horizontal axis 122 is therefore an approximate measure of rotation of eye 102 relative to reference line 120.

Most images used in commercial iris identification comply with ISO/IEC 19794-6, the international standard for iris image interchange. However, it is also possible to perform iris identification with images in other formats, and images that do not comply with the ISO standard can be processed using the methods described herein.

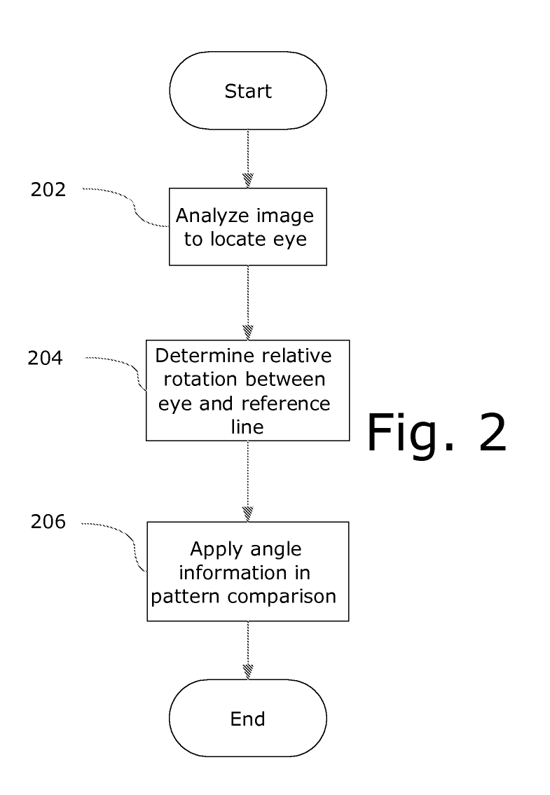

FIG. 2 is a flow chart showing an example method for processing digital data of an image of an eye to perform biometric iris identification. In step 202, the digital eye image data is electronically analyzed to find the location of the eye in the image. The eye may be located, for example, by a library function provided for use in iris matching processes. As examples, iris algorithm libraries developed by Retica Systems, Inc. of Waltham, Mass. and Iritech, Inc. of Fairfax, Va. include functions that locate the center of the eye in a digital image.

Other functions for finding the eye location can also be developed by those skilled in the art, based on the known characteristics of the image under analysis. Examples of image characteristics that can be used to help located the eye, which may be combined as desired, include the fact that an eye image typically presents a generally round iris with a round pupil in its center. Circular patterns in the image can be filtered based on size to eliminate those that are not part of an eye image. The diameter of the iris in images from a particular camera will be within a predetermined range for that camera. The iris diameter is determined by the distance at which the image is taken, the lens used, and the resolution of the imager. For example, the LifeSaver® LS-1 camera, manufactured by Eye Controls, LLC of Chantilly, Va., generates raw images of 1024×768 pixels with the iris is typically between 200 and 250 pixels in diameter. A raw image that is larger than the standard 640×480 ISO iris image is very helpful when performing eye angle analysis according to the methods described herein, since the wider view provided by the larger image makes it more likely that the entire width of the eyelids and the corners of the eye will be within the image field. When this visual data is available it can be used to more easily determine the angle of the eye.

As another way of verifying the eye location, illuminators used in capturing the image provide a known reflection pattern on the surface of the eye that can be detected by processing the image data. Since the eye surface is more reflective than the skin of the face, the image can be filtered to emphasize the known reflection pattern which will appear in the region of the eye or pupil and not in other spots on the face.

After the eye is located, processing continues with step 204 in which the image is electronically analyzed to determine an angle of relative rotation between the eye and a reference line of the image. The reference line may be chosen arbitrarily, as desired but is preferably the same (or parallel to the same line) for a given set of image data to facilitate comparisons within the data set. As a typical convention in iris identification, the target eye position is horizontal, parallel to the central horizontal axis of an image of 640×480 or greater, approximately centered in the image. Thus, preferably the target reference line(s) will be horizontal, i.e. parallel to the horizontal edges and horizontal central axis of the image. However, a reference line that is vertical or that is not parallel to an edge or central axis can also be selected if desired.

In an embodiment, the angle of relative rotation is determined by directly calculating an angular measurement. In another embodiment, an angular range indication is calculated rather than a precise value. The angular range indication may, for example, indicate the angle of rotation to the closest five degrees. In another embodiment, the angle of relative rotation is determined by calculating another quantity or value that varies with or is otherwise indicative of a rotational relationship between the eye and the selected reference line. What is important is to determine some indication of the angle at which the eye was imaged so that this angle indication parameter can be used to compensate for rotation of the eye in the image to improve results in an iris identification process. In example embodiments, the angle of relative rotation or other quantity is calculated using one of the example methods described herein.

In step 206, the calculated angle of relative rotation, or other rotational indicator as just described, is used in a pattern comparison as part of a biometric identification process. The calculated value is used to compensate for eye images that are significantly rotated relative to the target reference line. This compensation can be accomplished at any desired stage of the iris identification process, and in a number of different ways.

In an embodiment of step 206, the angle of relative rotation is used at the image stage to digitally rotate the image so that the presentation of the eye has little or no rotation relative to the reference line, producing a rotation-normalized digital image. A rotation-normalized template is then generated from the rotation-normalized image either for storage as an enrollment template, or as a recognition template for comparison with stored enrollment templates. If all enrollment and recognition templates are rotation-normalized in this manner, the amount of potential eye rotation between templates is significantly reduced. Therefore, the comparison algorithm can be adjusted to provide a smaller range of compensation for eye rotation, making fewer comparisons and operating faster as a result. The amount of time saved in a one-to-many comparison with a large database is significant. This process can be performed on the image at any desired location or combination of locations, such as live at the point of capture, live at a storage and comparison point such as a local or centralized iris identification server, or at any desired location in later, offline processing. The process steps can be split in any desired manner between locations; as one example, the eye angle may be determined at a camera capture location and that information can be provided along with the image for further processing at a central location.

In another embodiment of step 206, a template is generated from the original digital image and the calculated angle of relative rotation is stored in association with the template or as part of the template. This data indicating the angle of presentation of the eye is used as an input to an iris matching engine to guide the matching engine in performing more efficient rotational comparisons. In the prior art, iris matching engines typically performed a series of rotational comparisons within a predetermined range, without regard to how the eye may have been presented in the image. In this embodiment, rather than performing a standard series of relative rotational comparisons, a modified matching engine is provided wherein the rotational compensation function of the matching engine can be set to compensate for the measured rotation of that specific image. The measured rotations of the images from which the two templates were generated may be summed to determine a relative rotation of the images from which the two templates were generated. That relative rotation is implemented by the matching engine which rotates the templates to match the relative eye rotation of the base images. In this manner, a single comparison or at most a small number of comparisons can then be performed to accurately determine whether the two templates match, simultaneously compensating for rotation of the eye in both base images.

Optionally, in some embodiments, eye angles are measured in real time during image capture and those images in which the eye is apparently rotated beyond a limit set in the software are rejected. Audible and/or visible indications of an angular aiming error can be provided to the subject or a camera operator, and image capturing then continues until an image with an acceptable angle of rotation is obtained. The acceptable angle of rotation can be set to a small value, such as plus or minus three degrees or five degrees of rotation, in which case the images produced may be suitable for direct template generation, and the range of rotational compensation in the matching engine can be reduced accordingly.

As another option, the acceptable angle of rotation can be set to a larger value such as plus or minus (clockwise or counterclockwise) 15 degrees, 20 degrees or 30 degrees. This allows an image to be obtained when the camera is held at a significant angle relative to the eye, but will not permit a valid image capture if the camera is grossly misused, for example, positioned sideways. If the acceptable angle of rotation is set to a larger value as in this example, it will be desirable to combine this establishment of broad limits on acceptable rotation in an image with either normalizing the image and template, or providing eye angle information to the matching engine, as described in various embodiments herein.

In an embodiment, a limit on acceptable angle of rotation is applied during offline processing of previously captured image data. Images having eye rotation beyond a predetermined limit are rejected. Images having eye rotation within an acceptable range (below the predetermined limit) are accepted. Accepted images may be processed according to the other embodiments disclosed herein or a combination of these embodiments. For example, the image data may be rotation-normalized before template generation, or calculated eye rotation information may be stored for later use during the matching process.

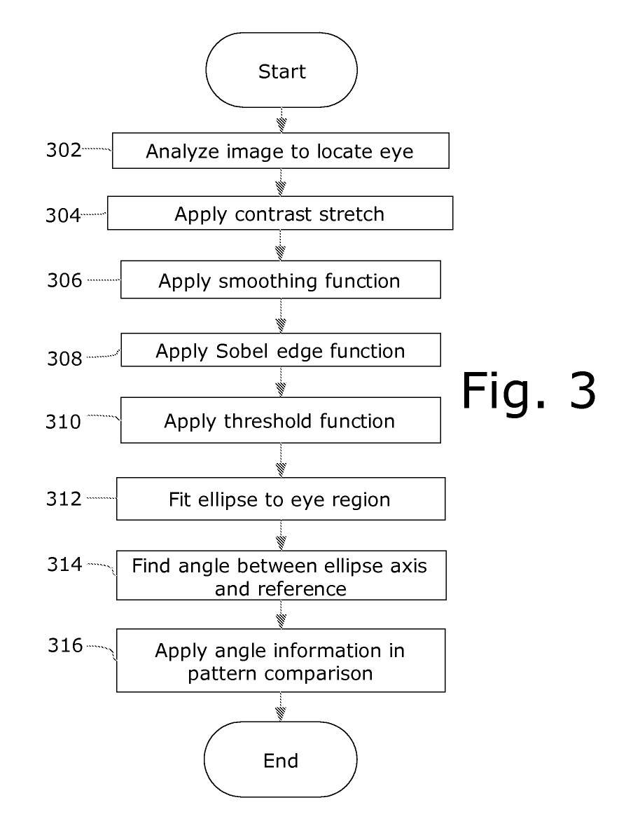

FIG. 3 is a flow chart showing one method of estimating eye rotation in an image using digital image analysis. Beginning with step 302, the center of the eye in the image is located, for example by using image analysis library routines provided with commercially available iris identification software for this purpose as described previously. In step 304, a contrast stretching function is applied at least to the eye region. Then in step 306, a smoothing or defocusing algorithm is then applied at least to the eye region. As an example, convolution with a Gaussian operator can be used for this purpose. In step 308 an edge detection function, for example a Sobel edge detection function, is applied. In step 310 a thresholding function is applied to the resulting data. The result is an image that is fuzzy and contains a visible, generally elliptical shape. In step 312, an ellipse-fitting algorithm is applied to the image. In an embodiment, the center of the fitted ellipse is set to the estimated coordinates of the eye's center.

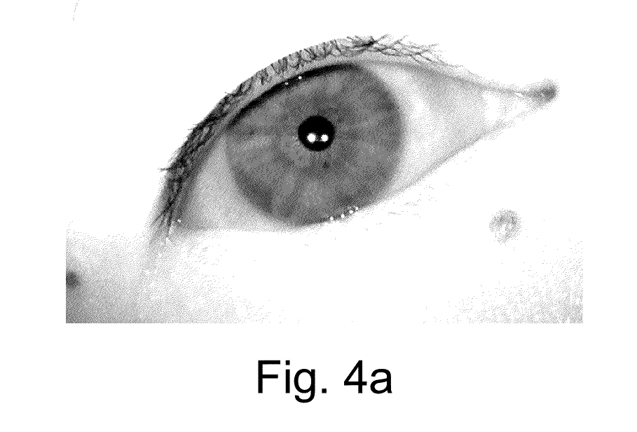

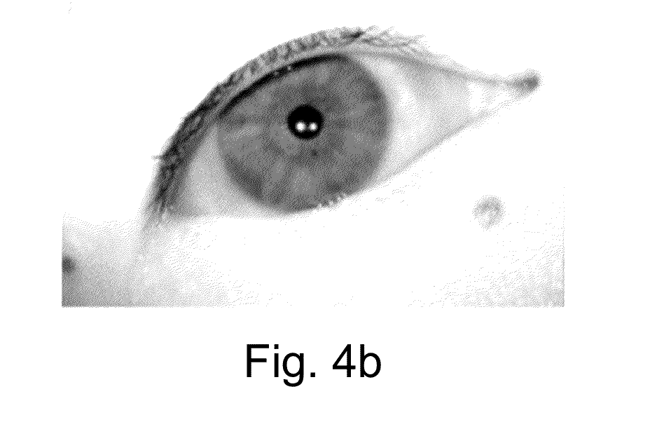

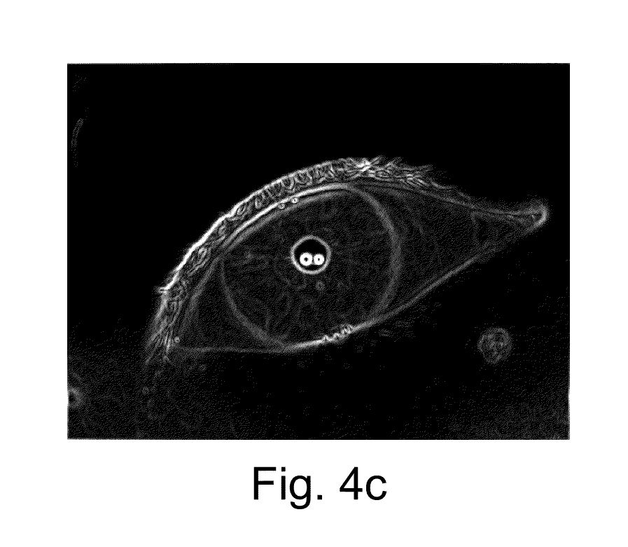

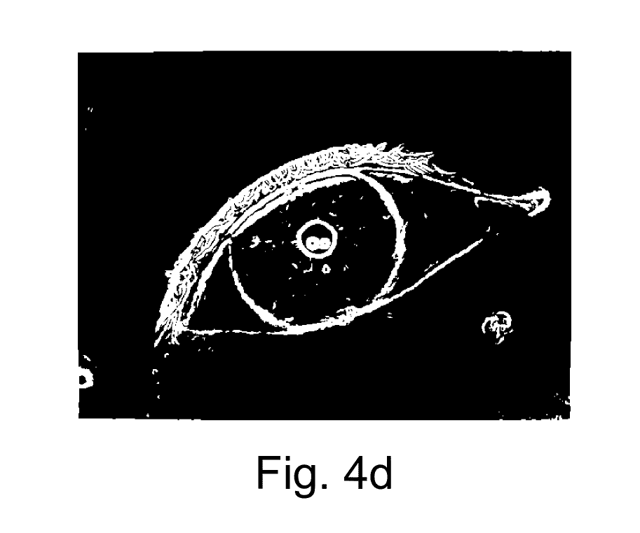

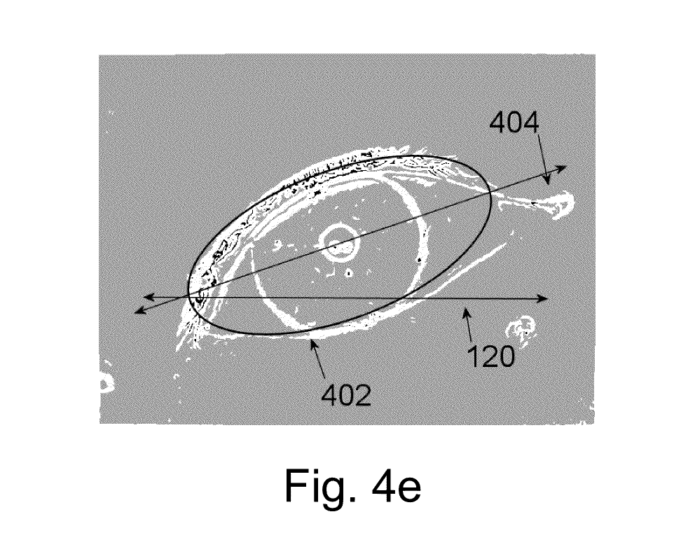

FIGS. 4a through 4e are provided as an example illustration of the process of FIG. 3. FIG. 4a shows the basic eye image of FIG. 1 with contrast stretching applied as described in step 304 of FIG. 3. FIG. 4b shows the image of FIG. 4a with a smoothing function applied as described in step 306 of FIG. 3. FIG. 4c shows the image of FIG. 4b with edge detection applied as described in step 308 of FIG. 3. FIG. 4d shows the image of FIG. 4c after application of the threshold function described in step 310 of FIG. 3. Finally, FIG. 4e shows the image of FIG. 4d with an ellipse fit to the image as described in step 312 of FIG. 3. To provide better visibility of the fitted ellipse and the reference lines and numbers in FIG. 4e, the contrast in this image has been reduced, however it should be understood that this is merely to increase visual clarity for purposes of this disclosure and is not a necessary part of the image processing method disclosed.

As shown in FIG. 4e, the fitted ellipse 402 has a central longitudinal axis 404. A reference axis 120 is also shown. Referring again to FIG. 3, in step 314, an angle θ between the fitted ellipse 402 and reference axis 120 (all shown in FIG. 4e) is determined. This determination is made using conventional algebraic and trigonometric methods for finding an angle between two intersecting lines.

In step 316 of FIG. 3, the resulting angular information is then stored or otherwise applied to facilitate iris pattern comparisons. For example, the angular information may be stored for future reference and/or used to normalize the angle of the image or stored pattern data extracted from the image.

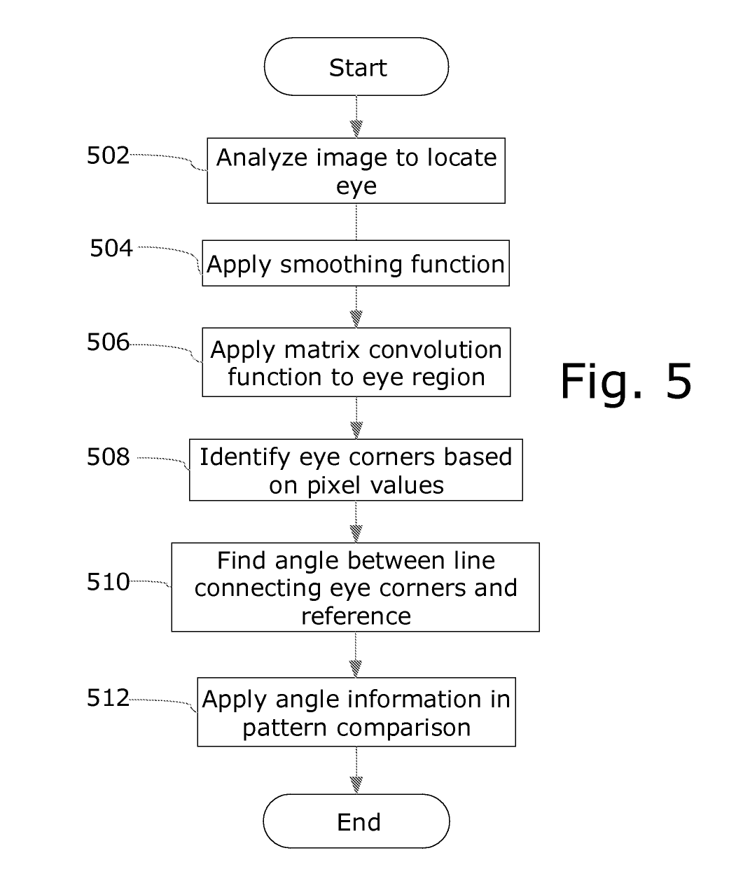

FIG. 5 is a flow chart illustrating another example embodiment of a process for determining the relative angle of the eye in an image. This example embodiment is a viable method for identifying the eye angle but is somewhat less preferred than the embodiment of FIG. 3, which is believed to provide a more accurate rotational estimate in some cases.

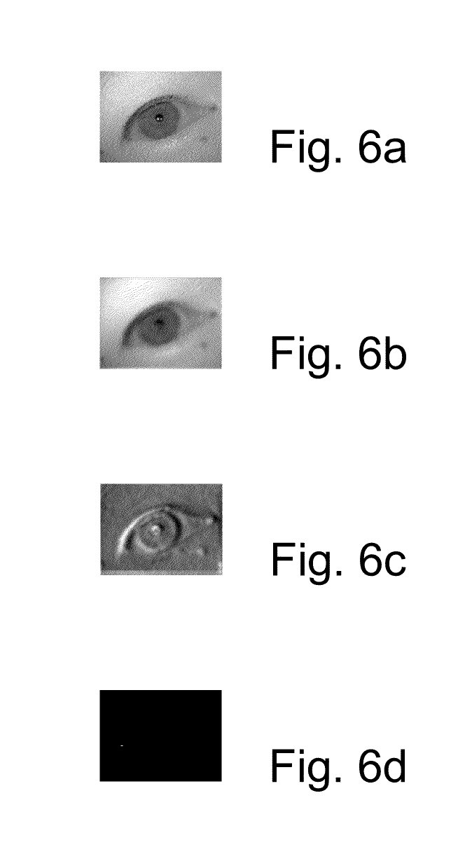

In step 502, the center of the eye is located and a region that is likely to encompass the eyelids and corners of the eye is determined based on the eye center location. The region encompassing the eye image is also preferably reduced in size to increase the speed of further processing in this method (see FIG. 6a). In step 504 a smoothing function is applied to the reduced size image (see FIG. 6b).

In step 506, a matrix that defines a right corner pattern is convolved with the pixel values of the iris image within at least the identified eye region (see FIG. 6c). This maximizes the pixel values at the right corner of the eye (appearing on the left side of the image when facing the eye). Similarly, a matrix that defines a left corner pattern is convolved with the original pixel values of the iris image within at least the identified eye region (not shown in FIG. 6). This maximizes the pixel values at the left corner of the eye, appearing on the right side of the image taken facing the eye.

The left and right corner pattern matrices are selected so that the convolution process results in highlighting these corner points of the eye. In an embodiment, the following matrices are used:

$$Left corner matrix \text{:}$$

$$\begin{matrix}- 1 & - 1 & - 1 & 1 & 1 & 1 \\ - 1 & - 1 & - 1 & - 1 & 1 & 1 \\ - 1 & - 1 & - 1 & - 1 & - 1 & 1 \\ 1 & 1 & 1 & 1 & 1 & 1\end{matrix}$$

$$Right corner matrix \text{:}$$

$$\begin{matrix}1 & 1 & 1 & - 1 & - 1 & - 1 \\ 1 & 1 & - 1 & - 1 & - 1 & - 1 \\ 1 & - 1 & - 1 & - 1 & - 1 & - 1 \\ 1 & 1 & 1 & 1 & 1 & 1\end{matrix}$$

As can be seen by the values and shaping of these example matrices, the two convolution processes generally reduce the pixel values within the eye and increases the pixel values on the borders producing a point value at the corner targeted by the matrix.

In step 508, the results of the right corner matrix convolution are thresholded and the location of the right corner of the eye is identified as the brightest point in the right-corner-convolved image data (see FIG. 6d). The threshold level can be determined by experimentation; for example, a threshold level of 254 was used to generate FIG. 6d from FIG. 6c. Similarly, although not illustrated in FIG. 6, the results of the left corner matrix convolution are thresholded to determine the location of the left corner of the eye, which will be the brightest point in the left-corner-convolved image data.

In step 510, an angle between a line connecting the two eye corners and the selected reference axis is determined using conventional algebraic and trigonometric methods for finding an angle between two intersecting lines, and in step 512 the angle information or rotational information derived from the angle information is used to facilitate an iris pattern comparison. For example, the angle information may be stored for future reference and/or used to normalize the angle of the image or stored pattern data extracted from the image.

In some cases, particularly with ISO standard iris images that only have 640×480 pixels, the image may not contain both eye corners. To accommodate such cases, the method described herein may be modified to identify a line intersecting a visible corner of the eye and the center of the eye, rather than two corners. The angle between this line and the reference line for the image will then provide an estimate of eye rotation in the image.

Most two-eye cameras are designed with two imagers, each aimed at a location where an eye is expected to appear. In such cameras, if the head is rotated significantly relative to the camera, in general at least one of the subject's two eyes will not be in view of the imagers. In other words, to obtain a valid image capture for both eyes with this type of two-eye camera, the head must be approximately level. The inherently limited ability of such cameras to capture eye images with significant rotation has been considered an advantage of such cameras. However, by implementing the teachings herein, the possibility of significant eye rotation in an image can be eliminated when using a less expensive single eye camera.

The teachings and methods herein can also be applied to two-eye cameras. In an embodiment using a two eye camera, the images or image portions showing each eye can be analyzed, and rotational compensation provided for both left and right eye images using any of the embodiments described herein.

Although illustrative embodiments have been described herein in detail, it should be noted and understood that the descriptions and drawings have been provided for purposes of illustration only and that other variations both in form and detail can be added thereupon without departing from the spirit and scope of the invention. The terms and expressions herein have been used as terms of description and not of limitation. Thus, the breadth and scope of the present invention should not be limited by any of the above-defined example embodiments, but should be defined only in accordance with the following claims and their equivalents. The terms or expressions herein should not be interpreted to exclude any equivalents of features shown and described or portions thereof.

We claim:

1. A method for processing digital data of an image of an eye for biometric iris identification, comprising:
a. Performing electronic analysis of the digital image data to identify the location of the eye in the image;
b. Performing electronic analysis of the image to calculate an angle of relative rotation between the eye and a chosen image reference line;
c. Using said calculated angle of relative rotation to compensate for rotation of the eye relative to the image in a pattern comparison for biometric iris identification.

2. The method of claim 1 wherein step (c) includes the further step of generating a rotation-normalized iris identification template from said digital image data based on said angle of relative rotation.

3. The method of claim 2 wherein step (b) includes digitally processing the image to fit a generally elliptical template to the image at the eye location and calculating said angle of relative rotation based on a position of said elliptical template.

4. The method of claim 2 wherein step (b) includes convolution of the digital image data with at least one matrix to locate a corner of the eye.

5. The method of claim 1 wherein in step (c) said pattern comparison is performed by performing a digital rotation operation on at least one iris identification template to compensate for said calculated angle of relative rotation for comparison of said template to another template.

6. The method of claim 5 wherein step (b) includes digitally processing the image to fit a generally elliptical template to the image at the eye location and calculating said angle of relative rotation based on a position of said elliptical template.

7. The method of claim 5 wherein step (b) includes convolution of the digital image data with at least one matrix to locate a corner of the eye.

8. The method of claim 5 wherein said digital rotation operation is performed in an iris matching engine based on said calculated angle of relative rotation.

9. The method of claim 1 wherein step (b) includes convolution of the digital image data with at least one matrix to locate a corner of the eye.

10. The method of claim 1 wherein step (b) includes digitally processing the image to fit a generally elliptical template to the image at the eye location and calculating said angle of relative rotation based on a position of said elliptical template.

11. A method for processing digital data of an image of an eye for biometric iris identification, comprising:
a. Performing electronic analysis of the digital image data to identify the location of the eye in the image;
b. Performing electronic analysis of the image to calculate an angle of relative rotation between the eye and a chosen image reference line;
c. Using said calculated angle of relative rotation to limit further processing of images having a relative rotation between the eye and the image reference line outside of predetermined limits.

12. The method of claim 11 wherein in step (c), images having relative rotation greater than the predetermined limits are rejected.

13. The method of claim 12 including the further step of providing a human-perceivable indication in real time to a person involved in capturing image data when said calculated angle of relative rotation is outside predetermined limits.

14. The method of claim 11 including the further step of using said calculated angle of relative rotation to compensate for rotation of the eye relative to the image in a pattern comparison for biometric iris identification.

15. The method of claim 14 wherein step (c) includes the further step of generating a rotation-normalized iris identification template from said digital image data based on said angle of relative rotation.

16. The method of claim 15 wherein step (b) includes digitally processing the image to fit a generally elliptical template to the image at the eye location and calculating said angle of relative rotation based on a position of said elliptical template.

17. The method of claim 15 wherein step (b) includes convolution of the digital image data with at least one matrix to locate a corner of the eye.

18. The method of claim 14 wherein in step (c) said pattern comparison is performed by performing a digital rotation operation on at least one iris identification template to compensate for said calculated angle of relative rotation for comparison of said template to another template.

19. The method of claim 18 wherein step (b) includes digitally processing the image to fit a generally elliptical template to the image at the eye location and calculating said angle of relative rotation based on a position of said elliptical template.

20. The method of claim 18 wherein step (b) includes convolution of the digital image data with at least one matrix to locate a corner of the eye.

21. The method of claim 18 wherein said digital rotation operation is performed in an iris matching engine based on said calculated angle of relative rotation.

22. An electronic data repository comprising:
a. at least one iris pattern template generated from a digital image of an eye, said iris pattern template compatible with at least one biometric iris identification matching engine, and
b. a data parameter associated with said iris pattern template representing a rotation of said eye relative to an imager used to generate said digital image.

23. An iris matching engine comprising:
a. a comparison routine that compares a first iris pattern template to at least one second iris pattern template to determine the probability that said first iris pattern template matches said second iris pattern template,
b. a rotation function that selectively performs a relative rotation between the first iris pattern template and the second iris pattern template to compensate for rotation of an eye during imaging, and
c. a control process that receives at least one angle parameter representing an estimated rotation of said eye in the image used to generate at least one of said first iris pattern template and said second iris pattern template, and activates said rotation function to perform a relative rotation between said first iris pattern template and said second iris pattern template, with said relative rotation derived at least in part from said angle parameter.

24. The iris matching engine of claim 23, wherein said control process receives angle parameters for said first and second iris pattern templates and activates said rotation function to perform a relative rotation equal to the differential between the rotation of the eye in the images used to generate said first and second iris pattern templates.
